(19) United States
(12) Patent Application Publication
(10) Pub. No.: US 2006/0152431 A1
(43) Pub. Date: Jul. 13, 2006

(54) Screen adjusting apparatus and method for use in multi-display unit

(75) Inventor: Young-Gil Song, Seoul (KR)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: DOUBLESIGHT DISPLAYS, LLC, FULLERTON (US)

(21) Appl. No.: 10/513,428

(22) PCT Filed: Feb. 27, 2004
(86) PCT No.: PCT/KR04/00412

§ 371 Date: Aug. 2, 2005

(30) Foreign Application Priority Data
Feb. 28, 2003 (KR) 10-2003-0012612

(51) Int. Cl. G09G 5/00

(52) U.S. Cl. 345/1.1

(57) ABSTRACT

There is provided a screen adjusting apparatus and method of a multi-display unit, in which a plurality of image display panels are selected and a screen display state of the selected image display panel is adjusted in a single operation.

### TECHNICAL FIELD

The present invention relates to a screen adjusting apparatus and method for use in a multi-display unit, and more particularly, to a screen adjusting apparatus and method for use in a multi-display unit, in which a screen display state of a specific panel is manipulated conveniently in case a plurality of flat-panel display units, such as LCD and PDP, are coupled. Further, the present invention relates to a method for adjusting an electronic equipment, in which a specific electronic equipment is conveniently selected and manipulated in case a plurality of homogenous equipments are used at the same time.

### BACKGROUND ART

A multi-display unit is an equipment which uses a plurality of small-sized display units at the same time and can be recognized as a single large-sized screen or integrated individual screens.

As a general flat-panel display unit becomes larger in size, its price rises rapidly. For example, 15-inch LCD panel costs 349 US dollars and 20-inch LCD panel costs 1,299 US dollars. Although a screen size increases slightly, the unit cost rises rapidly.

This is because an additional cost increases due to a technical difficulty and an increase of defective proportion, which are caused by in an additional formation of a driving circuit for forming large pixels, an addition of a manufacturing process and an additional formation of gate lines and data lines for large-sized monitors.

In order to solve these problems, there have been proposed various embodiments, in which a plurality of small-sized flat-panel display units are closely attached to form a large-size screen, or different display windows are provided on a small-sized panel. Such technologies are disclosed in U.S. Pat. Nos. 6,343,006 and 5,687,939.

However, technical spirits of these conventional technologies are to make it possible for a user to perform multi-tasking while watching a plurality of screens by only assembling a plurality of flat-panel display units as a single apparatus. Therefore, the conventional technologies have an inconvenience in that size or brightness of the screen are adjusted by individually controlling only the corresponding display unit in order to manipulate the respective small-sized display units.

Hereinafter, a construction of a conventional multi-display unit will be described in brief.

FIG. 1 is a perspective view of a conventional multi-display unit.

Referring to FIG. 1, the conventional multi-display unit includes a first display unit 1, a second display unit 11, a first manipulation unit 2 for adjusting a screen display state of the first display unit 1, and a second manipulation unit 12 for adjusting a screen display state of the second display unit 11.

The conventional multi-display unit further includes an input cable 4 through which external signals, such as power, a video signal and a manipulation signal, are inputted to the first and second display units 1 and 11.

FIG. 2 is a block diagram showing the detailed construction of the conventional multi-display unit and a driving method thereof.

Referring to FIG. 2, each of the display units 1 and 11 includes a power supply unit 31, an analog-to-digital converter (hereinafter, referred to as an ADC) 33, and a microprocessor 32. The power supply unit 31 receives a power inputted through the input cable 4 and converts it into a current suitable for a driving of the flat-panel display unit. The ADC 33 receives a video signal through the input cable 31 and converts it into a digital signal. The microprocessor 32 receives a manipulation signal through the input cable 4 in order for manipulating the display unit or a manipulation signal outputted from one of the manipulation units 2 and 12.

In addition, the conventional multi-display unit further includes a video scaler 34, a driver 35, and an image display panel 36. After the ADC 33 performs a sampling to convert the video signal into the digital signal, the video scaler 34 adjusts an image state displayed on the image display unit. After the video scaler 34 adjusts the display state (e.g., scale), the driver 35 processes the adjusted signal into a signal to be displayed on the image display panel 36.

In addition to the above necessary elements, an electrically erasable and programmable read only memory (EEPROM) for storing data and a plurality of filters for enhancing the reliability of signal processing may be further used.

In case the video signal is inputted in a form of digital signal, the ADC 33 may be unnecessary. For example, a video signal inputted through a digital video interface input need not pass through the ADC 33. Meanwhile, in case a video signal is inputted through an RGB input terminal or a component input terminal, the video signal may be processed after it is converted into a digital signal by means of the ADC 33.

The power supply unit 31 supplies an external power to the ADC 33, the video scaler 34, the driver 35 and the image display panel 36 in order for the signal processing. The microprocessor 32 controls the ADC 33, the video scaler 34, the driver 35 and the image display panel 36, such that control states of the respective units are adjusted for the signal processing.

In addition, in case two or more monitors are used, there are further provided a substrate for driving the respective monitors and a plurality of parts individually formed on the substrate.

Since the construction of the second display unit 11 is identical to that of the first display unit 1, a detailed description about the second display unit 11 will be omitted.

Meanwhile, the second display unit 11 is formed with the same parts and same manner as the first display unit 1 and configured to receive the power, the video signal and the manipulation signal. In other words, the second display unit 11 includes the terminals for receiving the plurality of signals, the parts for processing the signals, the power supply unit, and the microprocessor. Accordingly, the plurality of same parts, particularly the power supply unit and the microprocessor, are provided individually. As a result, the conventional multi-display unit has a disadvantage in view of costs.

In addition, since the manipulation units 2 and 12 individually adjust brightness, size and position of the individual display units 1 and 11, a batch adjustment is impossible. Therefore, there is a disadvantage in that a user must take an effort to adjust the same condition by means of the respective manipulation units 2 and 12, resulting in the user inconvenience.

For example, the manipulation units 2 and 12 are individually configured in the respective small-sized display units 1 and 11 and the user individually manipulates the manipulation units 2 and 12 in order to adjust size and brightness of the screen of the display units 1 and 11. Therefore, it is very inconvenient for the user. Further, since the manipulation units are individually used to adjust the states of the display units 1 and 11, it is impossible to adjust the states of all the display units at one time.

Further, since one microprocessor 32 is applied to one display unit, an entire cost of the display unit increases. Therefore, there is a problem in that it is impossible to make the most of an advantage that a cost is decreased when a plurality of small-sized display units are used.

### DISCLOSURE OF THE INVENTION

Accordingly, the present invention is directed to a screen adjusting apparatus and method of a multi-display unit that substantially obviates one or more of the problems due to limitations and disadvantages of the related art.

An object of the present invention is to provide a screen adjusting apparatus and method of a multi-display unit, in which screen display states of all small-sized display units are manipulated conveniently in case a plurality of small-sized display units are coupled and used as a single large-sized display unit.

Another object of the present invention is to provide a screen adjusting apparatus and method of a multi-display unit, in which the number of buttons for adjusting the respective screens of small-sized display units is decreased, such that a manufacturing cost of the display unit is reduced and an outer appearance of the multi-display unit looks more elegant.

According to one aspect of the present invention, a screen adjusting apparatus for use in a multi-display unit includes: a plurality of image display panels forming the multi-display unit as one assembly; a selection button for selecting a specific image display panel; a manipulation button for adjusting a screen of the selected image display panel; and a switching means for receiving a selection signal from the selection signal to select the image display panel and transmitting a manipulation signal of the manipulation button to the selected image display panel.

According to another aspect of the present invention, a screen adjusting apparatus for use in a multi-display unit includes: a plurality of image display panels forming the multi-display unit as one assembly; a manipulation button for transmitting a manipulation signal in order to adjust a screen display state displayed on the image display panels; a selection button for selecting a specific image display panel; a switching means for relaying the manipulation signal to the specific image display panel in response to the selection signal; and a microprocessor for processing the manipulation signal outputted from the manipulation button and transmitting the processed manipulation signal to the switching means.

According to further another aspect of the present invention, a screen adjusting method of a multi-display unit having a plurality of image display panels includes the steps of: selecting one or more specific image display panels among the plurality of image display panels; changing a display state of an indication means of the selected image display panel; selecting a specific image display panel desired by a user according to the display state of the indication means; and adjusting a screen display state of all selected image display panels.

According to still further another aspect of the present invention, a method for adjusting an electronic equipment includes the steps of: selecting a specific equipment among a plurality of homogeneous equipments in response to a selection signal; indicating the specific equipment selected in response to the selection signal; and manipulating the selected equipment in response to a manipulation signal.

According to the construction and method of the present invention, a large-sized screen can be provided at a low price and a convenience in use of the multi-display unit can be improved.

Specifically, since the screen display states of the respective small-sized display units are adjusted using a single key, the multi-display unit can be implemented at a low price and its appearance looks elegant.

Further, when homogeneous electronic equipments are used closely, the respective electronic equipments are manipulated conveniently and simply and there is no interference between the equipments.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a conventional multi-display unit;

FIG. 2 is a block diagram of a conventional multi-display unit;

FIG. 3 is a perspective view of a multi-display unit according to one embodiment of the present invention;

FIG. 4 is a perspective view of a multi-display unit according to another embodiment of the present invention;

FIG. 5 is a block diagram illustrating a screen adjusting apparatus of a multi-display unit according to one embodiment of the present invention;

FIG. 6 is a block diagram illustrating a screen adjusting apparatus of a multi-display unit according to another embodiment of the present invention;

FIG. 7 is a block diagram illustrating another embodiment of the present invention; and

FIG. 8 is a flowchart illustrating a screen adjusting method of a multi-display unit according to the present invention.

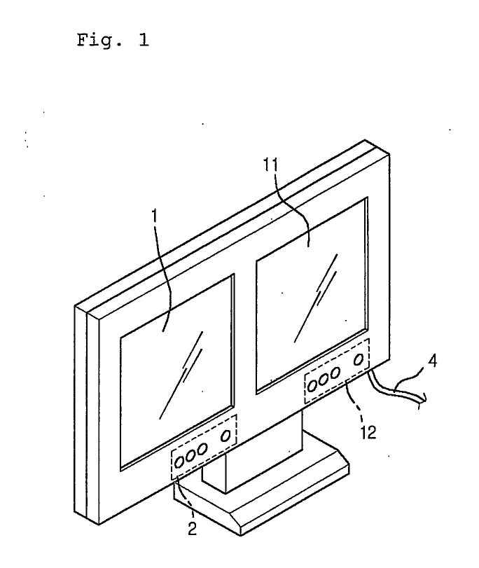

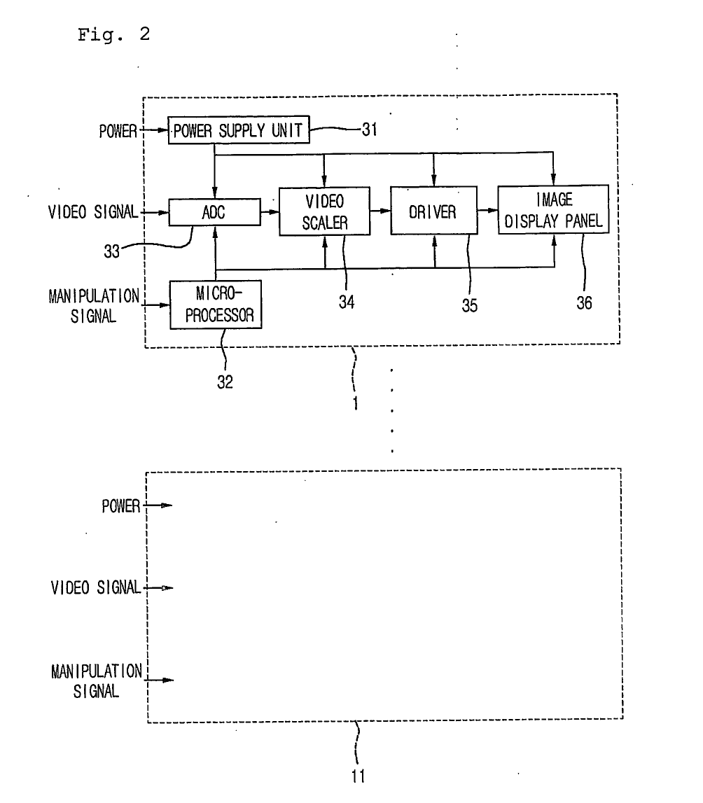

### BEST MODE FOR CARRYING OUT THE INVENTION

Hereinafter, preferred embodiments of the present invention will be described in detail with reference to accompanying drawings.

FIG. 3 is a perspective view of a multi-display unit according to an embodiment of the present invention.

Referring to FIG. 3, the multi-display unit of the present invention includes first and second display units 41 and 42 for displaying screens, a selection button 45 for selecting a specific display unit in case states of the screens displayed on the display units 41 and 42 are adjusted, a manipulation button 44 for manipulating a screen display state of the specific display unit selected by the selection button 45, and indication units 43 for indicating the display unit selected by the selection button 45. In addition, the multi-display unit can further includes a single substrate for processing a power, a video signal and a manipulation signal.

Specifically, the indication units 43 may be configured with a light-emitting diode and provided on right and left sides of the selection button 45. Since the indication unit 43 corresponding to the selected display unit emits a light, the user can recognize the selected display unit more conveniently. The indication units 43 are provided as many as the display units. For example, if there are four display units, four indication units are provided, so that the user can conveniently recognize the selected display unit. The indication units may be formed spaced apart from each other centering on the selection button 45. In addition, the indication units may be formed at positions adjacent to the respective display units.

Specifically, the manipulation button 44 includes several buttons, each of which carries out each function. For example, a volume button is provided with a pair of buttons that carry out a volume up/down function and an additional button for manipulating the respective display units is unnecessary.

According to another embodiment of the present invention, the indication unit 43 can be displayed on the screen of the selected display unit in a form of an on screen display (hereinafter, referred to as an OSD).

In detail, the respective display units can be selected by pushing the selection button 45. The number of cases that can be selected by pushing the selection button 45 is a sum of the number of the display units, a case that allows all the display units to operate equally at the same time, and a case that cancels the selection. For example, in case the number of small-sized display units is “N”, the number of cases that can be selected by the selection button 45 is at least “N+2”, that is, a sum of “N”, a case that selects all the display units at the same time, and a case that cancels the selection of all the display units. In addition, the number of cases of the display units that can be selected when the selection button 45 is pushed may be the number of cases of a subset that corresponds to the number of small-sized display units. For example, in case the number of the display units is three, the number of cases may be eight, that is, a case that all the display units are selected, a case that no display units are selected, three cases that only one display unit is selected, and three cases that two display units are selected.

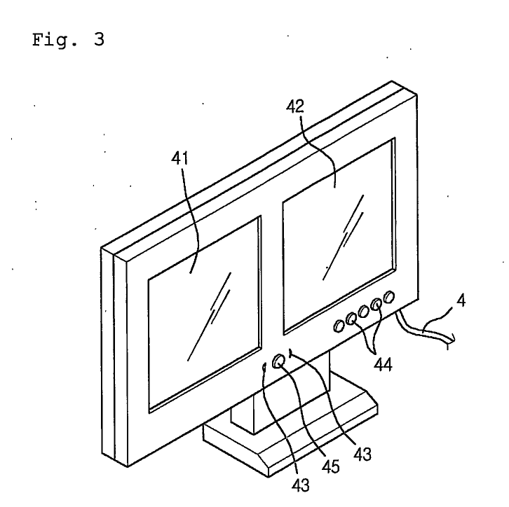

FIG. 4 is a perspective view of a multi-display unit according to another embodiment of the present invention.

Referring to FIG. 4, the multi-display unit according to another embodiment of the present invention is mostly identical to that shown in FIG. 3. A difference is that selection buttons are provided individually for selecting the respective display units. In other words, a left selection button 46 functions to select a display unit disposed at a left side from the center of the multi-display unit, and a right selection button 47 functions to select a display unit disposed at a right side from the center of the multi-display unit. Of course, the number of the selection buttons may increase as many as the number of the display units.

Herein, an operation of the selection buttons 46 and 47 will be described below.

If the user pushes the selection buttons 46 and 47 for selecting the respective display units to be manipulated, a specific display unit is selected and ready for manipulation. Then, the selected display unit is manipulated by means of the manipulation button 44. Of course, the indication units 43 for the respective display units are also operated.

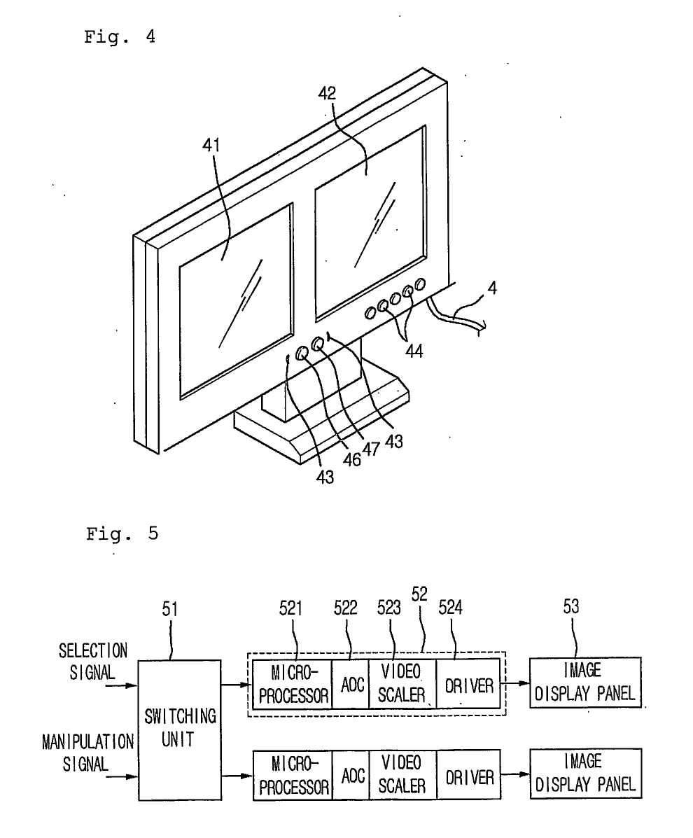

FIG. 5 is a block diagram illustrating a screen adjusting apparatus of the multi-display unit according to one embodiment of the present invention.

Referring to FIG. 5, the screen adjusting apparatus according to one embodiment of the present invention includes a switching unit 51, a one-chip processor 52 and an image display panel 53. The switching unit 51 receives a selection signal for indicating the display unit selected through the selection button 45 by the user, and a manipulation signal, inputted by the manipulation button 44, for manipulating screen size and brightness and the like. The one-chip processor 52 includes a microprocessor 521 for driving the respective display unit, an ADC 522, a video scaler 523 and a driver 524, all of which are formed inside one chip. Screen size and brightness displayed according to an output signal of the one-chip processor 52 are adjusted on the image display panel 53.

The screen adjusting apparatus can further include a control panel provided at the front of the switching unit 51 in order for converting physical signals of the selection button 45 and/or the manipulation button 44 into predetermined electric signals.

In addition, the one-chip processor 52 is provided by forming a plurality of function blocks, such as the microprocessor 521, the ADC 522, the video scaler 523 and the driver 524, inside one chip. The one-chip processor 52 is a single chip that processes the signals for driving the image display panel 53.

The switching unit 51 performs a function of connecting a transmission line to the specific image display panel 53 indicated by the selection signal and a function of relaying the manipulation signal.

Meanwhile, an operation state of the indication unit 43 shown in FIG. 3 can be manipulated by the control signals outputted from the switching unit 51 and/or the microprocessor 521. In other words, the display unit selected by the selection button 45 is indicated.

The one-chip processor 52 and the image display panel 53 are provided as many as the display units. Specifically, the one-chip processor 52 is configured to have a plurality of functions inside the single chip, thereby reducing a manufacturing cost of the multi-display unit.

Herein, a screen adjusting method of the multi-display unit shown in FIG. 5 will be described in brief. In case the user intends to adjust the screen displayed on the display unit, the display unit to be manipulated is selected by pushing the selection button (45 in FIG. 3) while watching a displayed state of the indication unit (43 in FIG. 3). At this time, the switching unit 51 is controlled by the selection signal of the selection button 45, so that a specific display unit is selected and the manipulation signal is transferred thereto.

After a connection line is formed by a control of the switching unit 51, the screen display state of the selected display unit is adjusted by the appropriate manipulation of the manipulation button 44, so that the screen is set to a desired state. At this time, the manipulation signal of the manipulation button 44 is transmitted through the switching unit 51 to the selected display unit alone.

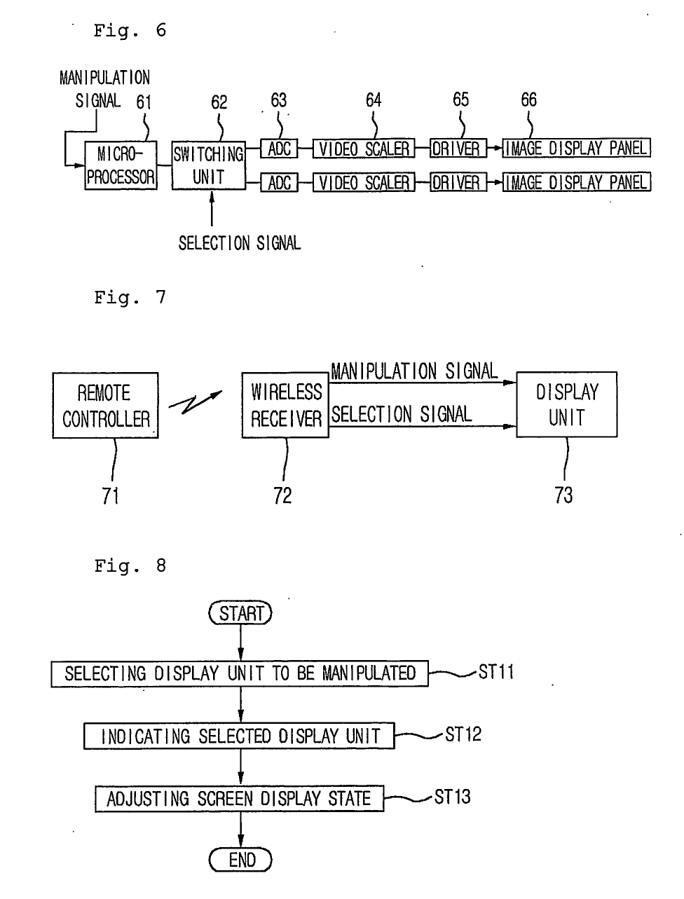

FIG. 6 is a block diagram illustrating a screen adjusting apparatus according to another embodiment of the present invention.

Referring to FIG. 6, the screen adjusting apparatus according to another embodiment of the present invention includes a microprocessor 61 configured to receive a manipulation signal, a switching unit 62 configured to receive a selection signal, an ADC 63 for processing an image signal displayed on an image display panel 66, a video scaler 64, and a driver 65. All functions of the ADC 63, the video scaler 64 and the driver 65 can be implemented inside one chip.

In addition, like the above-described embodiment shown in FIG. 5, each of the ADC 63 connected to the switching unit 62, the video scaler 64, the driver 65 and the image display panel 66 is provided as many as the display unit.

Herein, a screen adjusting method of the multi-display unit shown in FIG. 6 will be described in brief. In case the user inputs the selection signal by means of the selection buttons 45, the selection signal is inputted to the switching unit 62, so that a connection line of a specific display unit is set to a specific direction.

After the connection line is set toward a specific display unit by a control of the switching unit 62, the screen display state of the selected display unit is adjusted by the manipulation of the manipulation button 44. At this time, the manipulation signal inputted by the manipulation button 44 is transmitted to only the corresponding display unit connected by the switching unit 62, so that the screen display state of the corresponding display unit is adjusted. Since one microprocessor is used in the screen adjusting apparatus constructed as above, there is an effect that can reduce the price of the product.

FIG. 7 is a block diagram illustrating another embodiment of the present invention. A basic spirit of this embodiment is identical to that of the described-above embodiments. A difference is that the selecting and manipulating functions are carried out by a remote controller.

Referring to FIG. 7, a remote controller 71 includes at least a selection button and a manipulation button. A wireless receiver 72 receives a wireless signal outputted from the remote controller 71. A plurality of display units 73 receive a selection signal and a manipulation signal, which are outputted from the wireless reception unit 72, and perform a screen adjustment. The display unit 73 can be configured with the same structures shown in FIGS. 5 and 6. Preferably, the transmission/reception between the remote controller 71 and the wireless receiver 72 can be performed through an infrared communication.

It is an object of this embodiment to improve a convenience in case the user manipulates the screen display state of the display unit at a remote place. Specifically, the selection button for selecting a specific display unit and the manipulation button for manipulating the screen display state of the selected display unit are formed on one surface of the remote controller.

In this embodiment, the user can select the specific display unit through the selection button provided at the remote controller. In addition, the user can manipulate the screen display state of the selected display unit through the manipulation button provided at the remote controller. Therefore, once single or multiple display units are selected, the screen display states can be manipulated through the manipulation button of the remote controller, thereby improving the user convenience much more. This can be applied when it is difficult for the user to directly access the multi-display unit because the user and the display unit are spaced apart from each other by more than a predetermined distance. For example, this embodiment can be applied to a case that the display unit is used for TV.

Meanwhile, the remote controller is configured to select one display unit among the plurality of display units and manipulate the screen display state of the selected display unit. In addition, in order to select the display unit, the remote controller can select an external image system, such as TV, VTR, set-top box and DVD, which is connected to the display unit.

In other words, in the same manner how a specific display unit among the plurality of display units is selected by the selection signal and the selected display unit is manipulated by the manipulation signal, equipments such as VRT with built-in tuners or a special set-top box supporting a plurality of image outputs at the same time can be selected individually or wholly by the selection signal of the remote controller. In addition, as the user desires, only the selected image output terminal can be manipulated by the manipulation signal.

In more detail, as described above, the remote controller can select other equipments, such as TV, VTR, set-top box and DVD, as well as the display unit. In other words, in the same manner how a specific display unit among the plurality of display units is selected by the selection signal and the selected display unit is manipulated by the manipulation signal, a specific VTR among a plurality of VTRs is selected by the selection signal and the selected VTR is manipulated by the manipulation signal as the user desires. Of course, it can be equally applied to other electronic equipments.

For example, when a plurality of equipments (for example, a first VTR and a second VRT) using the same manipulation signal are used at the same time, a selection button is provided at one side of the remote controller. The first equipment and/or the second equipment of the same kind are/is selected according to pushing times and/or pushing duration of the selection button, and only the selected equipment is manipulated by the manipulation signal. In order for that, a switching unit for perform a switching operation in response to the selection signal can be provided inside the plurality of equipments using the same manipulation signal.

In this embodiment, an object of the present invention is different from that of a conventional universal remote controller in which the user convenience is provided by reducing the heterogeneous remote controllers for different purposes to one remote controller. In other words, in case the equipments performing the same function are assembled for outputting a plurality of images, this embodiment can control their manipulations by means of one remote controller. Therefore, it is possible to prevent an interference of similar signals and to efficiently use a frequency.

FIG. 8 is a flowchart illustrating a screen adjusting method of a multi-display unit according to the present invention.

Referring to FIG. 8, the user selects a display unit to be manipulated (ST11). As described in FIG. 3, the screen to be adjusted can be selected according to the pushing times of the selection button (45 in FIG. 3).

After the specific display unit is selected, the indication unit (43 in FIG. 3) is operated to indicate the selected display unit (ST12). The indication unit is connected with the specific display unit and can be provided with a light-emitting diode. The user can easily recognize the selected display unit since the light-emitting diode emits a light. In addition, the indication unit can be provided with an OSD, which is displayed on the selected display unit. Therefore, if the user selects a specific display unit, the OSD for adjusting a specific screen can be displayed on the screen of the selected display unit. Meanwhile, all or some display units of the multi-display unit can be selected.

The user can select the desired display unit by repeating the above steps ST11 and ST12.

After the display unit to be adjusted is selected, the screen display state of the selected display unit is adjusted by a manipulation of the manipulation button (44 in FIG. 3) (ST13).

Through the above steps, the screen adjusting method of the multi-display unit is completed.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

According to the present invention, the screens of the multi-display unit configured with the plurality of small-sized display units can be adjusted conveniently. The screens of the display units can be adjusted at the same time and the screen display states of all or some display units can be adjusted equally, thereby improving the user convenience.

In addition, since the number of the buttons for adjusting the screens of the display units is decreased, a manufacturing cost of the display unit is reduced and an outer appearance of the multi-display unit is elegant.

Further, since the multi-display unit can be manipulated, at the same time by the remote controller, the utility of the screen adjusting apparatus is expanded to other electronic equipments. As a result, the utility of the present invention is also increased. Furthermore, when homogeneous equipments having the same signaling system are used at the same place and the same time, a specific equipment is selected and the manipulation is performed to only the selected equipment, thereby improving the user convenience.

1. A screen adjusting apparatus for use in a multi-display unit, comprising:
a plurality of image display panels forming the multi-display unit as one assembly;
a selection button for selecting a specific image display panel;
a manipulation button for adjusting a screen of the selected image display panel; and
a switching means for receiving a selection signal from the selection button from the selection signal to select the image display panel and transmitting a manipulation signal of the manipulation button to the selected image display panel.

2. The screen adjusting apparatus according to claim 1, further comprising a one-chip processor, wherein the one-chip processor includes at least a microprocessor and a video scaler in order to adjust a screen display state of the image display panel in response to the manipulation signal, the manipulation signal being relayed by the switching means and processed by the microprocessor.

3. The screen adjusting apparatus according to claim 1, further comprising an indication means for indicating the image display panel selected by the selection button.

4. The screen adjusting apparatus according to claim 1, wherein the selection button and/or the manipulation button are/is formed on an outer surface of the multi-display unit.

5. The screen adjusting apparatus according to claim 1, wherein the selection button and/or the manipulation button are/is formed at a remote controller.

6. The screen adjusting apparatus according to claim 1, wherein the selection button is provided with a single button and the specific image display panel is selected according to pushing times of the selection button.

7. The screen adjusting apparatus according to claim 1, wherein there is a selection button provided for each image display panel.

8. The screen adjusting apparatus according to claim 1, further comprising a light-emitting diode formed on an outer surface of the display unit to indicate the specific image display panel selected by the selection button.

9. The screen adjusting apparatus according to claim 1, wherein the manipulation button includes a set of buttons each performing respective functions.

10. A screen adjusting apparatus for use in a multi-display unit, comprising:
a plurality of image display panels forming the multi-display unit as one assembly;
a manipulation button for transmitting a manipulation signal in order to adjust a screen display state displayed on the image display panels;
a selection button for selecting a specific image display panel;
a switching means for relaying the manipulation signal to the specific image display panel in response to the selection signal; and
a microprocessor for processing the manipulation signal outputted from the manipulation button and transmitting the processed manipulation signal to the switching means.

11. The screen adjusting apparatus according to claim 10, further comprising an indication means for indicating the image display panel selected by the selection button.

12. The screen adjusting apparatus according to claim 11, wherein the indication means is a light-emitting diode formed on an outer surface of the multi-display unit.

13. The screen adjusting apparatus according to claim 11, wherein the indication means is an OSD (On Screen Display), the OSD being displayed on the image display panel.

14. A screen adjusting method of a multi-display unit having a plurality of image display panels, comprising the steps of:
selecting one or more specific image display panels among plurality of image display panels;
changing a display state of an indication means of the selected image display panel;
selecting a specific image display panel desired by a user according to the display state of the indication means; and
adjusting a screen display state of all selected image display panels.

15. The screen adjusting method according to claim 14, wherein the step of selecting the image display panel is carried out by repeatedly pushing a single selection button.

16. The screen adjusting method according to claim 14, wherein the specific image display panel is selected by an on/off operation of individual selection buttons matching with the respective image display panels.

17. The screen adjusting method according to claim 14, wherein the indication means is formed on an outer surface of the multi-display unit.

18. The screen adjusting method according to claim 14, wherein the indication means is an OSD, the OSD being displayed on the respective image display panels.

19. The screen adjusting method according to claim 14, wherein the screen adjustment of the image display panel is carried out by a set of manipulation buttons.

20. A screen adjusting apparatus for use in a multi-display unit comprising;
a plurality of image display panels forming the multi-display unit;
a selection button for selecting a subset of the image display panels.
a manipulation button for adjusting screens of the image display panels selected by the selection button; and
a switching means for transmitting a manipulation signal of the manipulation button to the subset of the selected image display panels.

21. The screen adjusting apparatus according to claim 20, wherein the selection button is provided with a single button and cases of the subset are changed by repeatedly pushing the selection button.

22. The screen adjusting apparatus according to claim 20, wherein the selection buttons are individually provided to the respective image display panels.

23. A method for adjusting an electronic equipment comprising the steps of:
selecting a specific equipment among a plurality of homogeneous equipments in response to a selection signal;
indicating the specific equipment selected in response to the selection signal; and
manipulating the selected equipment in response to a manipulation signal.

24. The method according to claim 23, wherein the equipment includes a switching means for performing a switching operation in response to the selection signal.

25. The method according to claim 23, wherein the electronic equipment is a display unit.

26. The method according to claim 23, wherein the equipment includes a switching means for switching on/off a transmission of the manipulation signal.

27. The method according to claim 23, wherein the selection signal and the manipulation signal are outputted from a remote controller.

28. The method according to claim 23, wherein the selection signal and the manipulation signal are manipulated by a button formed on the equipment as one body.

29. The method according to claim 23, wherein the selection signal and/or the manipulation signal are/is manipulated by a button formed on a remote controller.
